(19) United States
(12) Patent Application Publication
(10) Pub. No.: US 2014/0263149 A1
(43) Pub. Date: Sep. 18, 2014

(54) Container With Coupling Features

(71) Applicant: Portola Packaging, Inc., Downers Grove, IL (US)

(72) Inventors: Gary L. Berge, Crystal Lake, IL (US); Mike Xiaoli Ma, San Jose, CA (US)

(73) Assignee: Portola Packaging, Inc., Downers Grove, IL (US)

(21) Appl. No.: 14/212,326

(22) Filed: Mar. 14, 2014

Related U.S. Application Data
(60) Provisional application No. 61/783,609, filed on Mar. 14, 2013.

(51) Int. Cl. B65D 1/02; B67B 3/20; B65D 41/04

(52) U.S. Cl. CPC B65D 1/0246; B65D 41/04; B67B 3/20
USPC 215/44; 215/235; 53/490

(57) ABSTRACT

A container is provided. The container includes a neck. The neck includes coupling features. A first closure is configured to be coupled to the container by a first coupling feature. A second closure is configured to be coupled to the container by a second coupling feature.

### CROSS-REFERENCE TO RELATED PATENT APPLICATION

This application is a Non-Provisional of 61/783,609, filed Mar. 14, 2013, which is incorporated herein by reference in its entirety.

### BACKGROUND OF THE INVENTION

The present invention relates generally to the field of containers. The present invention relates more specifically to containers configured to interact with closures with various coupling mechanisms.

Containers, such as bottles, may be filled with contents (e.g., liquids, solids, mixtures thereof, foods, drinks, etc.) and then sealed with a closure. There are various types of closures. Sealing of containers may be accomplished by automated machines and processes. Different types of closures having different closing mechanisms may be coupled to different types of containers to seal such containers.

### SUMMARY OF THE INVENTION

One embodiment of the invention relates to a method of closing a first container and a second container. The first and second containers each have a body and a neck extending from the body. The neck extends from a first open end to a second end proximate the body portion. The neck includes an outer surface. The neck includes a first thread extending radially outwardly. The neck defines a channel extending around at least a portion of the circumference of the neck between the first thread and the first open end. The method includes rotating a first closure relative to the first container to couple the first closure to the first container. The first closure has a closed upper portion. The first closure has an annular skirt extending downwardly from the closed upper portion. The annular skirt has an inner surface. The annular skirt includes a thread extending from the inner surface. The thread is configured to interact with the first thread of the first container to couple the first closure to the first container. The method includes rotating a second closure relative to the second container. The second closure has a closed top portion and an annular skirt extending downwardly from the closed top portion. The skirt has an inner surface. The inner surface defines a protrusion extending around at least a portion of the circumference of the skirt. The protrusion is configured to be located in the channel defined by the outer surface of the neck of the second container to couple the second closure to the second container.

Another embodiment of the invention relates to a closure. The closure includes a lower portion. The lower portion includes a removable portion configured to be removed to provide access to an aperture through the lower portion. The closure includes an upper portion pivotally coupled to the lower portion. The lower portion includes an upper wall and an annular skirt extending axially downwardly from the radial periphery of the upper wall from a first end proximate the upper wall to a second end distal from the upper wall. The annular skirt includes at least one discontinuous thread portion. The discontinuous thread portion extends radially inwardly. The lower portion includes a radially inwardly extending protrusion extending around at least a portion of one of the annular skirt and the upper wall. The protrusion extends in a direction generally parallel to the second end of the annular skirt.

Another embodiment of the invention relates to a container. The container includes a body portion. The container includes a neck portion. The neck portion extends from a finish defining an aperture through which an interior of the container may be accessed to the body portion. The neck portion includes an exterior surface and a first thread extending radially outwardly and circumferentially around at least a portion of the neck portion. The neck portion defines a channel extending circumferentially around at least a portion of the neck portion. The channel is configured to receive a protrusion of a closure therein to couple the closure to the container.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of an embodiment of a container closed by an embodiment of a closure;

FIG. 1A is a detail view of the closure coupled to the container of FIG. 1;

FIG. 2 is a perspective view of the container of FIG. 1 closed by another embodiment of a closure;

FIG. 2A is a detail view of the closure coupled to the container of FIG. 2;

FIG. 2B is a detail view of the closure coupled to the container of FIGS. 2 and 2A, with the closure in a dispensing configuration;

FIG. 3 is a detail perspective view of an embodiment of a container illustrating the neck of the container;

FIG. 4 is a top view of an embodiment of a container;

FIG. 5 is a cross-sectional view taken along the line 5-5 in FIG. 4;

FIG. 6 is a bottom perspective view of an embodiment of a closure in a dispensing configuration;

FIG. 7 is a bottom view of an embodiment of a closure in a dispensing configuration;

FIG. 8 is a top view of an embodiment of a closure in a dispensing configuration;

FIG. 9 is a cross-sectional view taken along the line 9-9 in FIG. 8;

FIG. 10 is a cross-sectional view taken along the line 10-10 in FIG. 8;

FIG. 11 is a bottom perspective view of an embodiment of a closure;

FIG. 11A is a top view of an embodiment of a closure coupled an embodiment of a container;

FIG. 12 is a cross-sectional view taken along the line 12-12 in FIG. 11;

FIG. 13 is a cross-sectional view taken along the line 13-13 in FIG. 11;

FIG. 14 is a top view of an embodiment of a closure in a dispensing configuration coupled to an embodiment of a container;

FIG. 15 is a cross-sectional view taken along the line 15-15 in FIG. 14;

FIG. 15A is a cross-sectional view illustrating an alternate embodiment of a closure in a dispensing configuration coupled to an embodiment of a container;

FIG. 16 is a side view of an embodiment of a closure in a dispensing configuration coupled to an embodiment of a container with a portion the skirt of the closure shown torn away;

FIG. 17 is a cross-sectional view taken along the line 17-17 in FIG. 16;

FIG. 18 is a detail perspective view of an embodiment of a container illustrating the neck of the container;

FIG. 19 is a detail side view of an embodiment of a container illustrating the neck of the container;

FIG. 20 is a top view of an embodiment of a container;

FIG. 21 is a cross-sectional view taken along the line 21-21 in FIG. 20;

FIG. 22 is a bottom perspective view of an embodiment of a closure;

FIG. 22A is a detail perspective view of an embodiment of a closure coupled to an embodiment of a container;

FIG. 23 is a top view of an embodiment of a closure coupled to an embodiment of a container;

FIG. 24 is a cross-sectional view taken along the line 24-24 in FIG. 23;

FIG. 25 is a perspective view of an embodiment of a closure;

FIG. 26 is a top view of an embodiment of a closure;

FIG. 27 is a cross-sectional view taken along the line 27-27 in FIG. 26;

FIG. 28 is a cross-sectional view taken along the line 28-28 in FIG. 26;

FIG. 29 is detail perspective view of an embodiment of a closure coupled to an embodiment of a container;

FIG. 30 is a top view of an embodiment of a closure coupled to an embodiment of a container;

FIG. 31 is a cross-sectional view taken along the line 31-31 in FIG. 30;

FIG. 32 is a cross-sectional view taken along the line 32-32 in FIG. 30; and

FIG. 33 is a flow chart illustrating a method of applying two different types of caps to one type of container.

### DETAILED DESCRIPTION

Referring generally to the figures, various embodiments of containers and closures are shown. Containers may be filled and closed with a closure in an automated process. For different applications, different closures may be used. For example, in an application in which the closure will be removed completely from the container to allow the contents of the container to be dispensed, a screw-on flat cap may be used, for example. In an application in which the closure will remain coupled to the container during dispensing of the contents of the container, a closure with a top portion that can be opened while a bottom portion remains coupled to the container, e.g., a stay-on flip-top closure, may be used, for example. Different closures may have different features that allow the closure to be coupled to a container and to maintain the closure coupled to the container. Additionally, different closures may be applied to different containers by different apparatuses, movements, mechanisms, steps, etc. Additionally, for example, rotation of a stay-on flip-top closure relative to the container should not remove the closure from the container. However, rotation of the screw-on flat cap relative to the container should remove the screw-on flat cap from the container.

During an automated process, when it is desired to switch to a different type of closure, often the automated process must be interrupted and both different containers and different closures are provided. Additionally, in some cases, different movements, process steps, mechanisms, etc., may be used to couple the different types of closures to containers.

Embodiments of the present containers allow different types of closures to be coupled to the same types of containers with the same movements, process steps, mechanisms, etc., which may provide for more efficient changes between different closure types.

Referring to FIG. 1, an embodiment of a container 20 closed by an embodiment of a closure 22 is illustrated. FIG. 1A is a detail view of the closure 22 closing the container. The closure 22 is a closure that is configured to be threadingly coupled to the container 20 and removed from the container 20 by rotating, e.g., unscrewing, the closure 22 relative to the container 20 to allow the contents of the container 20 to be dispensed.

Referring to FIG. 2, another embodiment of a closure 24 is illustrated coupled to the container 20. As shown in FIG. 2A, the closure 24 includes a lower portion 26 and an upper portion 28 pivotally coupled (e.g., by a living hinge, etc.) to the lower portion 26. The upper portion 28 is configured to be moved between a closed configuration, as shown in FIG. 2A, relative to the lower portion 26 and a dispensing configuration, as shown in FIG. 2B, relative to the lower portion 26. The closure 24, e.g., the lower portion 26, remains coupled to the container 20 as the upper portion 28 is moved between the closed and dispensing configurations. With reference to FIG. 2B, in one embodiment, the lower portion 26 includes a removable closure, shown as a pull-ring removable closure 30, closing a dispensing aperture defined in the lower portion 26. When contents of the container 20 are to be dispensed for a first time, the upper portion 28 may be moved to the dispensing configuration and the pull-ring may be pulled to remove the closure 30 from the lower portion 26, opening a dispensing aperture in the lower portion 26. The upper portion 28 may then be moved to a closed configuration to reclose the closure.

Embodiments of containers described herein may allow for coupling of different types of closures, such as closures 22 and 24, to the same type of containers.

With reference to FIGS. 3-5, the neck 32 of the container 20 is illustrated. The neck 32 includes a plurality of threads 34 circumferential spaced apart around the neck 32. The neck 32 extends from a first end extending from the body of the container 20 to a finish 36 defining a central aperture 38 through which the container 20 may be filled and through which the contents of the container 20 may be dispensed.

Located axially between the threads 34 and the finish 36, the neck 32 defines a channel 40 extending around the circumference of the neck 32. The neck 32 also includes a stop feature 41 located axially between the channel 40 and the threads 34 and extending radially outwardly. The neck 32 also includes a radial protrusion 42 located axially between the threads 34 and the body of the container 20.

With reference to FIGS. 6-8, the closure 24 is further described. The lower portion 26 of the closure 24 includes a downwardly extending skirt 44. The skirt 44 has an interior surface 46. The skirt 44 includes discontinuous inwardly projecting thread portions shown as thread leads 48 (only two of three thread leads shown in FIG. 6).

With reference to FIG. 9, in one embodiment, the upper portion 28 of the closure 24 includes a closed upper wall 29 and an annular wall 31 extending from the upper wall 29.

With further reference to FIG. 9, the lower portion 26 of the closure 24 includes an upper wall 50 and an annular central spout 52 projecting through the upper wall 50 and defining the central aperture 38. The central aperture 38 is sealed by the closure 30. A pull ring 54, e.g., integrally formed with the closure 30, may be grasped by a user and pulled upwardly to remove the closure 30 and open the aperture 38 through the spout 52. Located radially between the spout 52 and the skirt 44 is a downwardly extending annular wall 56, e.g., plug seal. In one embodiment, the downwardly extending annular wall 56 extends to an axial lower periphery.

In one embodiment, the annular wall 31 and the spout 52 are configured to interact to seal the closure when the upper portion 28 and the lower portion 26 are in a closed configuration. In one embodiment, the upper wall 29 of the upper portion 28 and the upper wall 50 of the lower portion 26 are spaced apart when the closure is in a closed configuration allowing a user to apply force to the lower side of the upper wall 29 to move the upper portion 28 into an open configuration relative to the lower portion 26.

The lower portion 26 also includes a radially inwardly extending protrusion, shown as radially inwardly protruding ring 58 extending axially downwardly and radially inwardly between the annular wall 56 and the skirt 44. In one embodiment, the ring 58 is a locking ring. In another embodiment, the ring 58 is a locking bead. In one embodiment, the ring 58 extends around the lower portion 26 in a direction generally parallel with the axial lower periphery of the skirt 44. In one embodiment, the ring 58 extends around the entire circumference of the lower portion 26. In another embodiment, the ring 58 is interrupted, e.g., does not extend around the entire circumference of the lower portion 26. In one embodiment, the ring 58 extends downwardly to a lower axial periphery. In one embodiment, the lower axial periphery of the downwardly extending annular wall 56 is axially lower than the lower axial periphery of the ring 58.

A channel 60 is formed between the annular wall 56 and the protruding ring 58 in which the finish of a container will be located. In one embodiment, the radially outer surface of the protruding ring 58 is spaced apart from the inner surface 46 of the skirt 44, which may allow the ring 58 to deflect outwardly to allow the finish of a container to move into the channel 60.

With reference to FIG. 10, a stop feature 62 is located in an interruption in the inwardly protruding ring 58. The stop feature 62 extends radially inwardly from the skirt 44 and axially downwardly from the upper wall 50. In the illustrated embodiment, the stop feature 62 extends axially farther downward from the upper wall than the ring 58.

With reference to FIG. 11, a bottom perspective view of the closure 22 is illustrated. The closure 22 includes an annular skirt 64 extending downwardly from the periphery of a top wall 66. Extending radially inwardly from the inner surface of the annular skirt 64 are three lead threads 68. In one embodiment, the three lead threads 68 are spaced apart around the circumference of the annular skirt 64 and each extends approximately 60°. This configuration may provide for coupling the closure 22 and uncoupling the closure 22 from a container by rotating the closure 22 less than 360° relative to the container. In other embodiments, other suitable numbers and configurations of lead threads may be used. In other embodiments, continuous threads, e.g., extending more than 360° may be used. Coupled to the axial lower periphery of the annular skirt 64 distal from the top wall 66 is a tamper indicating feature, illustrated in FIG. 11 as a tamper band 70 configured to interact with a feature of a container to detach from the annular skirt 64 when the closure 22 is removed from a container.

With reference to FIGS. 11A, 12, and 13, the closure 22 is illustrated coupled to the container 20. Extending downwardly from the top wall 66 is an axially downwardly projecting annular wall 72. The wall 72 and the annular skirt 64 form a channel 74 therebetween in which the finish 36 of the container 20 will be located. The threads 34 of the container 20 and the threads 68 of the closure 22 are configured to interact such that rotation of the closure 22 relative to the container 20 allows the threads 34 and 68 to engage and couple the closure 22 to the container 20. With the closure 22 coupled to the container 20, the downwardly projecting annular wall 72 passes through the central aperture 38 of the container 20 and is located in the container 20. Additionally, the tamper indicating feature 70 is engaged with the downward-facing surface of the protrusion 42. When the closure 22 is removed from the container 20, the protrusion 42 prevents axial upward movement by the tamper indicating feature 70 causing the tamper indicating feature to detach from the annular skirt 44 and remain coupled on the container 20.

With reference to FIGS. 14-16, the closure 24 is illustrated coupled to the same container 20. The discontinuous thread leads 48 extending from the annular skirt 44 are arranged and configured on the skirt 44 such that they initially engage with the threads 34 of the container 20, but are sized and configured to pass through the threads 34 and disengage from and move axially downwardly past the threads 34 of the container 20 as the closure 24 continues to be rotated relative to the container 20. After and/or as the discontinuous thread leads 48 pass the threads 34 of the container 20, the inwardly protruding ring 58 continues to be moved axially downwardly until it is located in the channel 40. In one embodiment, the closure 24 is configured such that the inwardly protruding ring 58 is located in the channel 40 just as the discontinuous thread leads 48 pass and/or disengage from the threads 34 of the container 20. In one embodiment, the ring 58 is biased inwardly and projects into the channel 40 of the container 20 coupling the closure 24 to the container 20. In one embodiment, the space between the ring 58 and the inner surface of the skirt 44 may allow the ring 58 to deflect radially outwardly to allow the ring 58 to pass the finish 36 of the container 20, with the ring 58 resiliently springing back radially inwardly when the ring 58 reaches the channel 40.

With reference to FIG. 15A, in another embodiment, a closure 24′ includes an inwardly protruding ring 58′ that extends radially inwardly from the inner surface of an annular skirt 44′, e.g., without providing a gap between the inner surface of the skirt 44′ and the ring 58′. The ring 58′ may be compressed to allow the ring 58′ to pass over the finish of a container and may re-expand into the channel 40 when the ring 58′ reaches the channel 40. In some embodiments, the ring 58′ may be resistant to compression to provide for secure coupling of the closure 24′ to the container 20.

In one embodiment, the configuration of the ring 58 in FIG. 15, e.g., relieved bead configuration, may reduce the amount of axial downward force, e.g., top load, to apply the closure to a container as compared to the ring 58′ configuration in FIG. 15A and may provide reduced hoop strength as compared to the ring 58′ configuration in FIG. 15A.

FIG. 16 shows the closure 24 and the container 20 with a radially outer portion of the skirt 44 torn away to illustrate the interaction of the stop feature 41 of the container 20 and the stop feature 62 of the closure 24. With reference to FIGS. 16 and 17, the closure 24 may be coupled to the container 20 by a mechanism that rotates the closure relative to the container 20. When the ring 58 of the closure 24 is located in the channel 40 (not shown in FIG. 16), the mechanism may continue to rotate the closure 24 until the stop feature 62 of the closure 24 encounters and interacts with the stop feature 41 of the container 20.

In one embodiment, the mechanism rotating the closure 24 may detect the resistance to further rotation provided by the stop feature 41 and stop rotating the closure 24. In another embodiment, it may be desired to have the closure 24 coupled to the container 20 in a predetermined rotational orientation. The stop feature 41 may be configured to deter further rotation of the closure 24 relative to the container 20 when the closure 24 is located at the desired rotational orientation relative to the container 20.

With reference to FIG. 18, the neck 121 of another embodiment of a container 120 is illustrated. The neck 121 extends from a first end defining a central aperture 123 of the container 120 to a second end extending from the body of the container 120. The neck 121 includes pairs of upper 122 and lower 124 discontinuous threads. The pairs of threads 122 and 124 are circumferentially spaced apart around the container neck, e.g., approximately 120° apart, etc. While three pairs of discontinuous threads 122 and 124 are illustrated, in other embodiments, other suitable numbers of threads may be used. With reference to FIGS. 18-21, the upper 122 and lower 124 threads are angled axially downwardly, away from the finish 126, in a clockwise direction.

With reference to FIG. 22, another embodiment of a closure 128 is illustrated. The closure 128 includes an annular skirt 129. Extending from radially inwardly from the annular skirt 129, the closure 128 includes thread leads 130 configured to interact with the threads 122 and 124 of the container 120 to couple the closure 128 to the container. FIG. 22A illustrates the closure 128 coupled to the neck of the container 120. The closure 128 is a closure that is configured to be threadingly coupled to the container 120 and removed from the container 120 by unscrewing the closure 128 from the container 120 to allow the contents of the container 120 to be dispensed.

The closure 128 has various features similar to the closure 22, and therefore, differences from closure 22 are the focus of the description of closure 128. With reference to FIG. 24, the closure 128 is configured to be rotated relative to the container 120 to engage the threads 130 and 132 of the closure 128 with the threads 122 and 124 of the container 120.

With reference to FIG. 25, another embodiment of a closure 138 is illustrated. The closure 138 has various features similar to the closure 24, and therefore, differences from closure 24 are the focus of the description of closure 138. With reference to FIGS. 27 and 28, the lower portion of the closure 138 has a downwardly extending annular skirt 139. Extending radially inwardly from the inner surface of the skirt 139 are a plurality of discontinuous thread portions shown as thread leads 140. Located axially above the thread leads 140 and extending radially inwardly from the inner surface of the skirt 139 is a coupling feature extending continuously around the inner circumference of the skirt 139, shown as a detent ring 142. In one embodiment, the detent ring 142 extends around the lower portion of the closure 138 in a direction generally parallel with the axial lower periphery of the skirt 139. In one embodiment, the detent ring 142 is a locking ring. In another embodiment, the detent ring 142 is a locking bead. In one embodiment, thread leads are spaced apart by approximately 120°. In another embodiment, thread leads are spaced apart by approximately 90°. In other embodiments, other suitable numbers and configurations of thread leads may be used.

With reference to FIGS. 31 and 32, the closure 138 is configured to be rotated relative to the container 120 with the thread leads 140 initially engaging and then pass through and past the container threads 122 and 124. As the closure 138 continues to be rotated and moved axially downward relative to the container 120, the detent ring 142 will be deformed and/or displaced radially outwardly to allow the detent ring 142 to pass axially downwardly over the upper threads 122. After passing the upper threads 122, the detent ring 142 is configured to resiliently reform and/or move back radially inwardly after passing the upper threads 122 to be located in the channel 144 formed between the upper threads 122 and the lower threads 124. In one embodiment, the detent ring 142 is trapped between the threads 122 and 124 coupling the closure 138 to the container 120. In one embodiment, the closure 138 is rotatable relative to the container 120 with the detent ring 142 located in the channel 144, however, rotation of the closure 138 relative to the container 120 does not uncouple the closure 138 from the container 120.

In one embodiment, an automated mechanism, apparatus, and/or process may be used to couple closures such as, e.g., closures 22 and 24, to containers such as, e.g., container 20, or closures such as, e.g., closures 128 and 138 to containers such as, e.g., container 120. It may be advantageous for both closures to be able to be coupled to the container, for example, so that different types of closures, e.g., for different applications, may be coupled to the container without introducing a different type of container into the automated mechanism, apparatus, and/or process. It may also be advantageous for the mechanism, apparatus, and/or process to execute the same steps and/or movements regardless of which type of closure is being coupled to the container, e.g., without the need for recognition, reprogramming, or change in movements or steps by the mechanism, apparatus, and/or process to apply the different closures to the container.

In one embodiment, the heights of the closures 22 and 24 are the same. In another embodiment, the heights of the closures 128 and 138 are the same. In one embodiment, the diameters of the closures 22 and 24 are the same. In another embodiment, the diameters of the closures 128 and 138 are the same.

In one embodiment, the closures 22 and 128 are low profile flat caps. In one embodiment, the closures 24 and 138 are caps such as, e.g., flip-lid caps, hinged lid caps, dispensing caps, etc.

In one embodiment, rotating vacuum chucks may be configured to rotate embodiments of closures described above relative to containers and to provide axial force on the closures relative to the containers to couple the closures to the containers.

In another embodiment, closures may be coupled to containers by application of downward axial force without rotation of the closures relative to the containers.

With reference to FIG. 33, an embodiment of a method for coupling different closures to similar containers is illustrated. In step 200, a first type of closure is obtained by a rotation mechanism, e.g., a vacuum chuck. In step 202, the rotation mechanism applies the first type of closure to a first container and rotates the closure relative to the first container, coupling the first type of closure to the first container. In step 204, the rotation mechanism obtains a second type of closure different from the first type of closure. In step 206, the rotation mechanism applies the second type of closure to a second container having substantially the same features and being substantially similar to the first container and rotates the second type of closure relative to the second container, coupling the second type of closure to the second container. In one embodiment, the movements and/or process steps of the rotation mechanism are the same in steps 202 and 206. In one embodiment, the first type of closure is coupled to the first container by different features than the second type of closure is coupled to the second container.

In one embodiment, the first and second containers have features as described above with regard to container 20, the first closure has features as described above with regard to closure 22, and the second closure has features as described above with regard to closure 24. In another embodiment, the first and second containers have features as described above with regard to container 120, the first closure has features as described above with regard to closure 128, and the second closure has features as described above with regard to closure 138.

In one embodiment, the protrusion 58 is segmented. In another embodiment, the protrusion 58 is continuous. In one embodiment, the detent ring 142 is segmented. In another embodiment, the detent ring 142 is continuous.

In another embodiment, a closure is provided. The closure includes an annular skirt. The annular skirt includes a radially inwardly extending protrusion. A container including a neck is provided. The neck includes a bottom lead thread. The closure is configured to be coupled to the container with the radially inwardly extending protrusion trapped below the bottom lead thread of the neck to maintain the closure coupled to the container.

In one embodiment, a closure, such as those described above, may be coupled to the neck of a container in a rotatable fashion such that the closure may be realigned relative to the bottle.

Once a flat or specialty cap (e.g., flip-lid cap, hinged lid cap, dispensing cap, etc.) closure is in a fully applied position on the bottle finish by screw or snap fit, it is attached to the bottle finish and cannot be removed easily without external means. It can be free to rotate into alignment position with specialty bottles (which have handles or other special features which require the alignment of the cap) or can be locked out of rotation by an alternate means. Thus a low profile flat cap or a specialty cap can share the same bottle neck finish and function as intended for both types of caps.

A low profile flat cap or specialty cap may have a single lead thread or a multiple or three lead thread on its internal cap skirt wall cooperative with continuous or interrupted or segmented external thread structure of a bottle neck finish. Also the low profile flat or specialty cap may have a cap detent lock ring at an upper or mid portion of its internal cap skirt cooperative with a neck finish detent ring or groove structure at the upper portion of the bottle neck finish.

Embodiments of containers herein may be plastic containers formed from any suitable plastic, e.g., thermoplastic, thermoset, polyethylene terephthalate, high density polyethylene, polyvinyl chloride, low density polyethylene, polypropylene, etc. In other embodiments, containers described herein may be formed from any other suitable material. Embodiments of closures herein may be formed from any suitable type of plastic, e.g., thermoplastic, thermoset, polyethylene terephthalate, high density polyethylene, polyvinyl chloride, low density polyethylene, polypropylene, etc., and may include other suitable rubbers, gaskets, etc. Embodiments of containers herein may be unitarily formed, e.g., molded, blow molded, injection molded, extruded, etc.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A method of closing a first container and a second container, the first and second containers each having a body and a neck extending from the body, the neck extending from a first open end to a second end proximate the body portion and including an outer surface, the neck including a first thread extending radially outwardly, the neck defining a channel extending around at least a portion of the circumference of the neck between the first thread and the first open end, the method comprising:
rotating a first closure relative to the first container to couple the first closure to the first container, the first closure having a closed upper portion and an annular skirt extending downwardly from the closed upper portion, the annular skirt having an inner surface and including a thread extending from the inner surface, the thread configured to interact with the first thread of the first container to couple the first closure to the first container; and
rotating a second closure relative to the second container, the second closure having a closed top portion and an annular skirt extending downwardly from the closed top portion, the skirt having an inner surface, the inner surface defining a protrusion extending around at least a portion of the circumference of the skirt, the protrusion configured to be located in the channel defined by the outer surface of the neck of the second container to couple the second closure to the second container.

2. The method of claim 1, wherein the outer surface of the neck defines the channel.

3. The method of claim 1, wherein the neck includes a second thread and wherein the channel is defined by the first thread and the second thread.

4. The method of claim 1, wherein the container neck includes a first stop feature projecting radially outwardly, wherein the annular skirt of the second closure includes a second stop feature projecting radially inwardly, the method including detecting the first stop feature interacting with the second stop feature and discontinuing rotation of the second closure relative to the second container based on the detected interaction of the first stop feature and the second stop feature.

5. A closure comprising:
a lower portion including a removable portion configured to be removed to provide access to an aperture through the lower portion; and
an upper portion pivotally coupled to the lower portion;
wherein the lower portion includes an upper wall and an annular skirt extending axially downwardly from the radial periphery of the upper wall from a first end proximate the upper wall to a second end distal from the upper wall, the annular skirt including at least one discontinuous thread portion extending radially inwardly, the lower portion including a radially inwardly extending protrusion extending around at least a portion of one of the annular skirt and the upper wall, the protrusion extending in a direction generally parallel to the second end of the annular skirt.

6. The closure of claim 5, further comprising a stop feature extending radially inwardly from the annular skirt and axially downwardly to a location below the axial lower periphery of the radially inwardly extending protrusion.

7. The closure of claim 5, wherein the radially inwardly extending protrusion extends axially downwardly from the upper wall.

8. The closure of claim 5, wherein the radially inwardly extending protrusion extends radially inwardly from the annular skirt.

9. The closure of claim 5, wherein the discontinuous thread portion extends in a direction non-parallel with the direction in which the protrusion extends.

10. The closure of claim 5, wherein the lower portion includes an annular wall extending downwardly from the upper wall to a lower axial periphery, the annular wall being located radially inwardly from the annular skirt.

11. The closure of claim 10, wherein the radially inwardly extending protrusion includes a lower axial periphery and wherein the lower axial periphery of the annular wall is axially lower than the lower axial periphery of the radially inwardly extending protrusion.

12. The closure of claim 10, wherein the radially inwardly extending protrusion includes a lower axial periphery and wherein the lower axial periphery of the annular wall is axially lower than the lower axial periphery of the radially inwardly extending protrusion.

13. A container comprising:
a body portion; and
a neck portion extending from a finish defining an aperture through which an interior of the container may be accessed to the body portion, the neck portion including an exterior surface and a first thread extending radially outwardly and circumferentially around at least a portion of the neck portion, the neck portion defining a channel extending circumferentially around at least a portion of the neck portion, the channel being configured to receive a protrusion of a closure therein to couple the closure to the container.

14. The container of claim 13, including a radially outwardly projecting stop feature located axially between the first thread and the finish, the stop feature being configured to interact with a stop feature of the closure to inhibit rotation of the closure relative to the container.

15. The container of claim 13, wherein the channel is located axially above the first thread.

16. The container of claim 13, including a second thread located axially above the first thread, the first and second threads defining the channel therebetween.

17. The container of claim 13, including a closure including an upper wall having a radially outer periphery and an annular skirt extending axially downwardly from the radially outer periphery of the upper wall, the annular skirt including at least one radially inwardly extending thread, the at least one thread configured to engage with the first thread of the neck portion to couple the closure to the container, the closure including a tamper indicating feature coupled to the annular skirt, the container including a radially outwardly extending projection configured to interact with the tamper indicating feature to remove the tamper indicating feature from the annular skirt when the closure is removed from the container.

18. The container of claim 13, including a closure including an upper wall having a radially outer periphery and an annular skirt extending axially downwardly from the radially outer periphery of the upper wall to a lower axial periphery, the closure including a radially inwardly extending protrusion and at least one discontinuous thread portion located between the radially inwardly extending protrusion and the lower axial periphery of the annular skirt.

19. The container of claim 18, wherein the radially inwardly extending protrusion extends from the upper wall and has a radially outer surface, and wherein the radially outer surface of the radially inwardly extending protrusion is spaced apart from the radially inner surface of the annular skirt.

20. The container of claim 18, wherein the radially inwardly extending protrusion extends continuously around the inner circumference of the annular skirt.
